(19) United States
(12) Patent Application Publication
(10) Pub. No.: US 2026/0014414 A1
(43) Pub. Date: Jan. 15, 2026

(54) EXERCISE MAT

(71) Applicant: THE ASSET BRAND LLC, Scottsdale, AZ (US)

(72) Inventor: Tessa VICENTE, Scottsdale, AZ (US)

(21) Appl. No.: 19/269,867

(22) Filed: Jul. 15, 2025

Related U.S. Application Data
(60) Provisional application No. 63/671,624, filed on Jul. 15, 2024.

(51) Int. Cl. A63B 21/00; B32B 5/24; B32B 25/04; B32B 25/10

(52) U.S. Cl. CPC A63B 21/4037; B32B 5/24; B32B 25/04; B32B 25/10; B32B 2250/03; B32B 2262/0276; B32B 2307/726; B32B 2307/744; B32B 2471/04

(57) ABSTRACT

A mat for supporting a user during an exercise is disclosed. The mat includes a first layer having moisture absorption or moisture wicking properties and defining an upper surface, a second layer positioned below and coupled to the first layer and resiliently deformable to define cushioning, and a bottom surface for selective interfacing with an environmental surface to limit movement of the mat relative to the environmental surface. The mat is flexibly manipulable between a first expanded configuration and a second compact configuration, the second compact configuration having a reduced area in comparison to the first expanded configuration.

### CROSS-REFERENCE TO RELATED APPLICATIONS

This application claims the benefit of priority pursuant to 35 U.S.C. § 119(e) of U.S. Provisional Patent Application No. 63/671,624, filed Jul. 15, 2024, entitled “EXERCISE MAT,” which is hereby incorporated by reference herein in its entirety.

### FIELD

The described embodiments relate generally to an exercise mat. More particularly, the present embodiments relate to a moisture absorbing mat.

### BACKGROUND

Conventional yoga or exercise mats often include a single piece of material providing some padding and support for an individual, such as when their hands or body would otherwise be in contact with the floor. The yoga mats may have a top surface to reduce slipping of the individual while attempting to hold a pose, position, or perform a workout.

However, common yoga mats often include a material that repels moisture. During periods of more intense exercise, or forms of yoga such as hot yoga, an individual may generate increased amounts of perspiration that drip or puddle on the mats. In such an example, the top surface becomes slippery and unstable. Further, the floor surface may additionally become slippery due to perspiration or other moisture draining from the mat onto the floor, and the mat may move relative to the floor surface. In such an example, the movement of the user relative to the mat or the floor increases a risk of the user falling or injuring themselves during exercise.

Further, laying in one's own perspiration is often unsanitary and uncomfortable. Separately placing an absorbative material on the yoga mat may increase the risk of movement of the material or the user relative to the floor. Further, the separate material from the mat may bunch or fold while the user moves, providing an uneven surface impairing balance, or chafe the user during use. Accordingly, there is a need for a mat or support surface providing stable support and moisture absorption properties.

### SUMMARY

In one example, a mat for supporting a user during an exercise is disclosed. The mat includes a first layer having moisture absorption or moisture wicking properties and defining an upper surface, a second layer positioned below and coupled to the first layer and resiliently deformable to define cushioning, and a bottom surface for selective interfacing with an environmental surface to limit movement of the mat relative to the environmental surface. The mat is flexibly manipulable between a first expanded configuration and a second compact configuration, the second compact configuration having a reduced area in comparison to the first expanded configuration.

In some examples, the mat further includes a third layer defining the bottom surface and coupled to the second layer, wherein the third layer comprises a material having a sufficiently high coefficient of friction to limit movement of the mat relative to the environmental surface.

In some examples, a combined thickness of the first layer, the second layer, and the third layer is between and including 2 mm to 8 mm.

In some examples, a combined thickness of the first layer and the second layer is between and including 2 mm to 8 mm.

In some examples, one or more of the first layer, the second layer, or the third layer are selectively separable.

In some examples, the first layer, the second layer, or the third layer are fixedly coupled.

In some examples, one or more of the first layer, the second layer, or the third layer are defined by two or more panels, and the two or more panels are movable relative to each other.

In some examples, the third layer covers a lower surface of the second layer.

In some examples, the third layer is defined by two or more separately defined portions and positioned in a spaced arrangement at a lower surface of the second layer.

In some examples, the third layer defines a plurality of apertures extending from the bottom surface to a lower surface of the bottom layer.

In some examples, a fourth layer comprising the same properties as one or both of the first layer and second layer is selectively coupled to the upper surface or the bottom surface.

In some examples, the first layer is defined by a first material comprising synthetic fibers.

In some examples, the synthetic fibers comprise polyester and nylon.

In some examples, the bottom surface includes one or more pores, a tacky coating, grooves, or ridges.

In some examples, the second layer defines the bottom surface. The first layer defines the top layer.

In one example, an exercise mat for supporting a user during an exercise is disclosed. The exercise mat includes a top layer comprised of a moisture absorptive material and defining a top surface, a second layer coupled to the first layer opposite the top surface and formed of a resiliently deformable material, and a bottom surface for selective interfacing with an environmental surface to limit movement of the mat relative to the environmental surface. The exercise mat is flexibly manipulable between a first expanded configuration and a second compact configuration, the second compact configuration having a reduced area in comparison to the first expanded configuration.

In another example, the top layer is comprised of a fibrous material, and the second layer is comprised of rubber.

In another example, the top player is suede, and the second layer defines the bottom surface and is comprised of rubber.

In another example, the top layer and the second layer terminate at a first end and a second end, a corner region extends between the first end and the second end, and the corner region is oriented at an angular offset relative to the first end.

In another example, the angular offset is 45 degrees.

In another example, a combined thickness of the top layer and the second layer, is between and including 2 millimeters to 8 millimeters.

In one example, an exercise mat for supporting a user during an exercise is disclosed. The exercise mat includes a top layer comprised of a moisture absorptive material and defining a top surface and a lower surface opposite the top surface, a second layer positioned coupled to and extending coextensively along the lower surface of the first layer and formed of a resiliently deformable material, and a bottom surface for selective interfacing with an environmental surface to limit movement of the mat relative to the environmental surface. The top layer and the second layer are flexibly manipulable between a first expanded configuration and a second rolled and compact configuration, the second rolled and compact configuration having a reduced area in comparison to the first expanded configuration.

In another example, the top player is suede, and the second layer defines the bottom surface and is comprised of rubber.

In another example, the top layer and the second layer terminate at a first end and a second end, a corner region extends between the first end and the second end, and the corner region is oriented at an angular offset between and including approximately 30-60 degrees relative to the first end.

A number of feature refinements and additional features are applicable in the first aspect and contemplated in light of the present disclosure. These feature refinements and additional features may be used individually or in any combination. As such, each of the following features that will be discussed may be, but are not required to be, used with any other feature combination of the first aspect.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts a perspective view of an example mat;

FIG. 2 depicts a cross sectional view of the example mat of FIG. 1;

FIG. 3A depicts a top plan view of one example configuration of the mat described herein;

FIG. 3B depicts a top plan view of one example configuration of the mat described herein;

FIG. 3C depicts a top plan view of one example configuration of the mat described herein;

FIG. 3D depicts a top plan view of one example configuration of the mat described herein;

FIG. 4A depicts a bottom plan view of one example configuration of the mat described herein;

FIG. 4B depicts a bottom plan view of one example configuration of the mat described herein;

FIG. 4C depicts a bottom plan view of one example configuration of the mat described herein;

FIG. 4D depicts a bottom plan view of one example configuration of the mat described herein;

FIG. 5A depicts a partial exploded view of one example of the mat and a selectively connectable padding and grip panel;

FIG. 5B depicts a partial exploded view of one example of the mat and a selectively connectable towel and padding panel;

FIG. 6A depicts a partial exploded view of another example of the mat;

FIG. 6B depicts a bottom plan view of the mat of FIG. 6A; and

FIG. 6C illustrates a perspective view of another example of the mat.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to a mat having two or more layers to both support a user or person engaging in a workout and to absorb moisture. Yoga mats are commonly used by a user engaging in a workout or exercise such as yoga for padding and for providing a stable surface to hold various poses or positions. The mats may additionally be used for core workouts or other exercises where padding or a stable support surface is beneficial. In some workouts or forms of yoga, such as hot yoga, a user may generate perspiration or consumer a hydrating beverage, which may drip or spill on the mat or surrounding surfaces. The mat disclosed herein includes moisture absorption properties and a supporting surface for the user for a comfortable and stable workout.

The mat includes a top or first layer having absorptive properties to capture moisture, such as sweat or from beverages. For example, the material of the first layer may be a moisture absorbing material that may wick moisture away from the top surface or retain moisture to prevent puddling that would otherwise result in slickness due to moisture at the top surface. The mat includes a second layer positioned at least partially below the first layer for padding or support to the user. The second layer may be resiliently compressible or deformable to support a portion of the user's body over a greater surface area to decrease stress concentrations. The mat includes a bottom surface providing frictional resistance or adhesive properties for selectively interfacing with an environmental surface (e.g. floor, ground, etc.) to limit or prevent movement of the mat relative to the environmental surface. A mat that limits relative movement relative to the environmental surface or by the user along the top surface of the mat, such as by absorbing moisture or by improved engagement with the environmental surface, provides a stable platform for a user to engage in exercise. The bottom surface may be defined by an optional third or bottom layer having adhesive properties or providing increased friction with the environmental surface.

The mat may be assembled or formed with the first moisture absorbing layer on the top and the second supportive layer below the first layer. In some examples, the second layer is at the bottom or middle. In some examples, the optional third layer is at or defines the bottom. In some examples, the first, second, or third layer may be fixedly attached. In other examples, at least one of the layers may be selectively removable. For example, the first layer may be selectively removable for washing, cleaning, or drying. In other examples, the first layer and the second or third layers are washable or cleanable together. In some examples, the optional third layer may be selectively attachable to increase or adjust the frictional resistance of the mat. The assembled mat may be generally rectangular, with a longer length than width to accommodate both a variety of standing and laying poses of a user. Each of the layers may be coextensive with the others, or one or more of the layers may have a greater width or length than the other layers, or the one or more the layers may be defined by one or more separate portions or panels.

In some examples, additional portions of the first, second, or optional third layers may be selectively added to the mat for increased absorption, padding or support, or to adjust a frictional resistance of the mat. In some examples, the additional portions may include two or more of the layers. For example, an additional or supplemental portion may include the first and second layers for both increased padding while maintaining the absorption properties of the mat. In some examples, an additional portion including the second layer and/or the third layer may be selectively placed beneath the mat for increased padding while maintaining or increasing sufficient frictional resistance.

Reference will now be made to the accompanying drawings, which assist in illustrating various features of the present disclosure. The following description is presented for purposes of illustration and description.

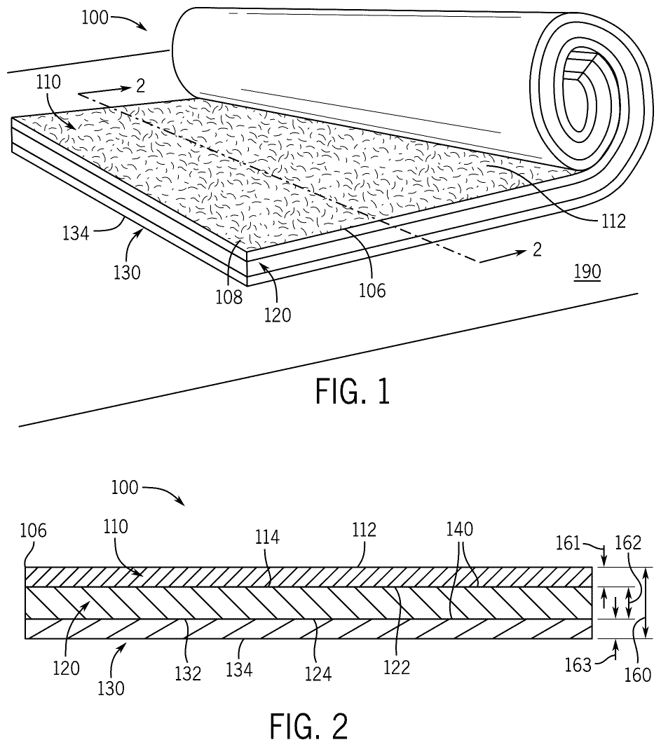

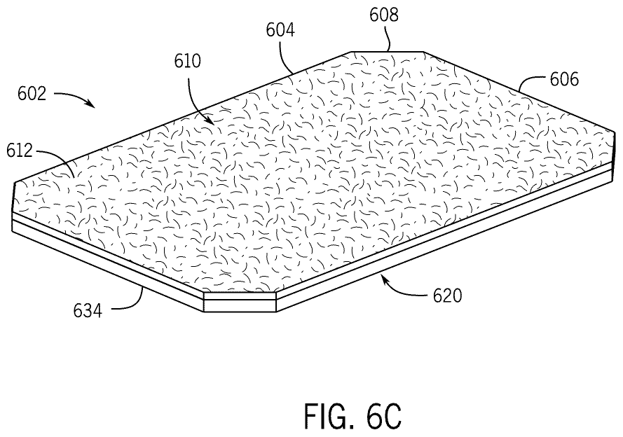

FIG. 1 depicts a mat 100 for use during a workout or exercise, such as yoga. The mat 100 may be generally rectangular or elongated. In some examples, the mat 100 may be elliptical, triangular, or a variety of other shapes that may be conducive to positions of a user engaging in a workout. As illustrated in FIG. 6C, the mat can be formed in various shapes or configurations for distinguishing aesthetic appearances. The mat 100 may be used as a workout surface on top of an environmental surface 190, which may be too stiff or too soft for a user to engage in a workout. For example, the environmental surface 190 may commonly be hard flooring such as wood, tile, cement, or the like. The environmental surface 190 may alternatively or additionally be carpets, grass or field surfaces, or the like.

The mat 100 disclosed herein includes a first layer 110 having moisture absorption or moisture wicking properties. The first layer 110 includes an upper surface 112 and a bottom surface 114 opposite the upper surface 112. The first layer 110 may be the top layer of the mat 100. Accordingly, the upper surface 112 of the first layer 110 may be the upper surface of the mat 100. The upper surface 112 may be where the user is positioned during use of the mat 100.

The material of the first layer 110 may be a moisture absorbing material and/or assist in evaporating moisture off of the mat 100. For example, the first layer 110 may wick moisture away from the top surface 112 or retain moisture to prevent puddling that would otherwise result in slickness due to moisture at the top surface 112. In some examples, the first layer 110 material may be a fabric or composed of fibers. In some examples, the material includes synthetic or natural fibers. The synthetic fibers may be made from materials such as polyester and nylon. In one example, the first layer 110 is defined by approximately 80% polyester and 20% nylon. The natural fibers may include bamboo, cotton, wool, or the like. In one example, the top layer is suede (e.g. leather or synthetic suede). In some examples, the material is a blend of two or more types of fibers. Additional materials or fibers may be added for aesthetic appearances, such as textures or coloring.

The moisture absorption properties of the first layer 110 may provide a more comfortable or stable surface for a user. By absorbing moisture, the user may be less likely to slip or fall. Further, the user may be more comfortable laying down or in a prone position in comparison to a conventional mat where puddles or pools of moisture may form.

The first layer 110 may have sufficient frictional resistance or traction for the user to maintain and hold various poses. For example, the material of the upper surface 112 may have texture or properties for sufficient grip by a user in various standing, laying, or other poses, such as where various combinations of the user's appendages are in contact (e.g. prone, kneeling, standing, or the like) with the upper surface 112. The texture may be similar to that of a terry cloth, microfiber, towel, or the like. In some examples, the texture of the upper surface 112 may be generally smooth to prevent chaffing of the user during a workout. In some examples, the first layer 110 may include materials or coatings having anti-microbial properties to prevent or limit growth of bacteria or mold.

The mat 100 includes a second layer 120. The second layer 120 includes a top or upper surface 122 and an opposing lower or bottom surface 124. The second layer 120 may be support or padding for the user during the workout. For example, the second layer 120 may be resiliently compressible or deformable to support a portion of the user's body, such as over a greater surface area, to decrease stress concentrations. The material of the second layer 120 may be one or more of a foam, polymer, rubber, cork, or similar material providing cushioning from impacts or support to the user. In some examples of the mat 100, combinations of materials for the second layer 120 may be used. The material of the mat 100 may be tailored to a specific use or surface of the mat 100. A mat 100 selected for use on hard flooring may include a second layer 120 providing more cushion (e.g. increased range of compression) or flexibility to increase the comfort of the user. A mat 100 selected for use on a softer flooring may have a comparably stiffer second layer 120 to provide a similar level of padding and support. In some examples, the second layer 120 may include materials or coatings having anti-microbial properties to prevent or limit growth of microbes such as bacteria or mold.

The mat 100 has a bottom surface 134. The mat 100 may optionally include a third layer 130. The third layer 130 or the second layer 120 may define the bottom surface 134. For example, bottom surface 124 and bottom surface 134 can be the same surface in some examples.

In examples with the third layer 130, the third layer 130 includes an upper surface 132 opposite the bottom surface 134. The third layer 130 may be a layer having features or properties with a sufficiently high coefficient of friction to limit the movement of the mat 100 relative to the environmental surface 190 during use. The third layer 130 may be formed from a material having adhesive properties, e.g. a tacky or sticky texture, or include features such as ridges, grooves, suction features, or pores to resist movement of the mat 100 relative to the environmental surface 190. For example, the third layer 130 features may increase a surface area of the bottom surface 134. In some examples, a coating may be applied to one of the second 120 or third layers 130 for adhesive or frictional properties. In some examples, the second layer 120, or specifically the bottom surface 124 of the second layer, can have some or all of the properties of the third layer 130 in addition to providing cushioning or support. For example, the second layer 120 can be resiliently flexible or compressible material having properties resulting in a sufficiently high coefficient of friction to limit the movement of the mat 100 relative to the environmental surface 190 during use.

The properties of the third layer 130, second layer 120, or bottom surfaces 124, 134, that limit movement of the mat 100 may be beneficial in providing a stable base for the user during a workout. For example, when perspiration or hydrating fluids spill on the environmental surface 190, the moisture may present a risk that a conventional yoga mat would slip or move, thereby inhibiting or disrupting a user from maintaining a pose or position. Instead, the bottom surface 134, as may be defined by the third layer 130, may maintain sufficient frictional resistance even when wet to maintain the position of the mat 100 on the environmental surface 190.

The mat 100 may be formed by connecting the first layer 110, second layer 120, and optionally the third layer 130. The first layer 110 may be a top layer and connected, at least in part, to the second layer 120. For example, the bottom 114 of the first layer 110 may be connected to the top 122 of the second layer 120. The second layer 120 may be a middle layer and the third layer 130 may be a bottom layer. In other examples, as illustrated in FIGS. 6A-6C and described herein, the second layer 120 may be the bottom most layer and the third layer can be omitted. For example, the bottom 124 of the second layer 120 may optionally be connected to the top 132 of the third layer 130.

The layers may be fixedly or selectively connected. The mat 100 may include one or more connection features 140 connecting the layers. The connection features 140 may be selectively connectable such as fasteners, snaps, hook and loop fasteners, adhesive strips or panels, or the like. In other examples, the connection features 140 may fixedly connect the layers. For example, the connection features 140 may be stitching, permanent adhesives, heat welds or bonded connections between the layers, or the like. The connection features 140 may be defined by or selectively positioned between two or more of the layers 110, 120, 130.

In examples where the layers 110, 120, 130 are selectively connected, the layers may be selectively removed for cleaning. For example, the first 110 or second layer 120 may be removable to wash or dry after absorbing moisture, such as perspiration. The third layer 130 may be removable for cleaning, such as to remove dust or debris that may reduce the frictional resistance of the mat 100. In examples where the layers 110, 120, 130 are fixedly connected, the fixed connections may limit movement of the layers relative to each other, providing a stable platform for workouts. In such an example, each of the layers 110, 120, 130 may be washable or cleanable together.

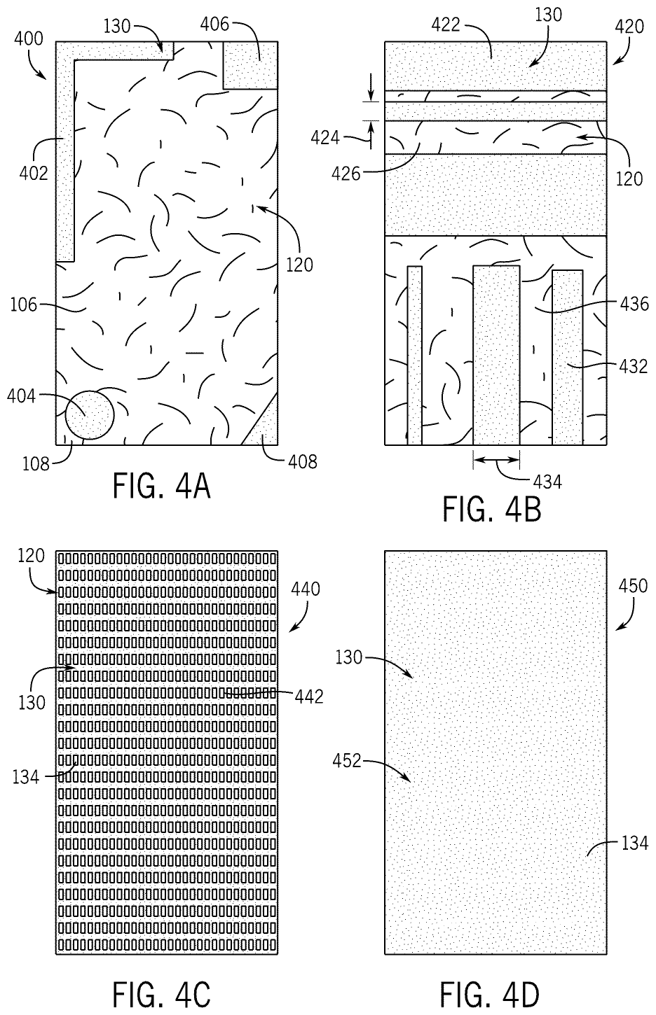

The mat 100 may be generally rectangular. Accordingly, the mat 100 may have a width 152, shown in FIG. 3A, and a length 154. For example, one or each of the layers 110, 120, 130 can be coextensive with one or all of the other layers 110, 120, 130. In another example, one or more of the layers 110, 120, 130 can be recessed inward relative to one or more of the other layers. The width 152 of the mat 100 may be less than the length 154. In such an example, the mat 100 may define corner regions 108. The corner regions 108 can be curved, angled, or the like. In one example, the corner regions 108 have an outer edge oriented at an angle relative to the sides such as at 45 degrees, 30 degrees, 60 degrees, or at a greater or lesser angle.

In some examples, the length 154 and width 152 may correspond to conventional yoga mats or towels. In one example, the length 154 and width 152 measure approximately 68 inches by 24 inches, respectively. In another example, the length 154 is approximately 76 inches and the width 152 is 26 inches. In some examples, the mat 100 may have a greater or lesser length 154 or width 152, such as to correspond to different heights of users, to provide space for multiple users or sufficient range of motion for various workouts. In some examples, the mat 100 may be elliptical, triangular, or shaped to correspond to a design. The mat 100 defines a periphery 106. The periphery 106 may include the perimeter and adjacent portions of the mat 100, or layers 110, 120, 130.

Each of the layers 110, 120, 130 may be coextensive or have different geometries. For example, each of the layers 110, 120, 130 may have a similar or same length or width corresponding to the length 154 or width 152 of the mat 100. For example, the third layer 130 may cover the second layer 120, or the first layer 110 may cover the second layer 120. In other examples, one or more of the layers 110, 120, 130 may be larger, smaller, or discontinuous with reference to the other layers 110, 120, 130. For example, one or more of the first layer 110, the second layer 120, or the third layer 130 may be defined by two or more panels or portions. The panels of the layer may be separate and movable relative to each other to customize the padding, moisture absorption, grip, or the like of the mat 100.

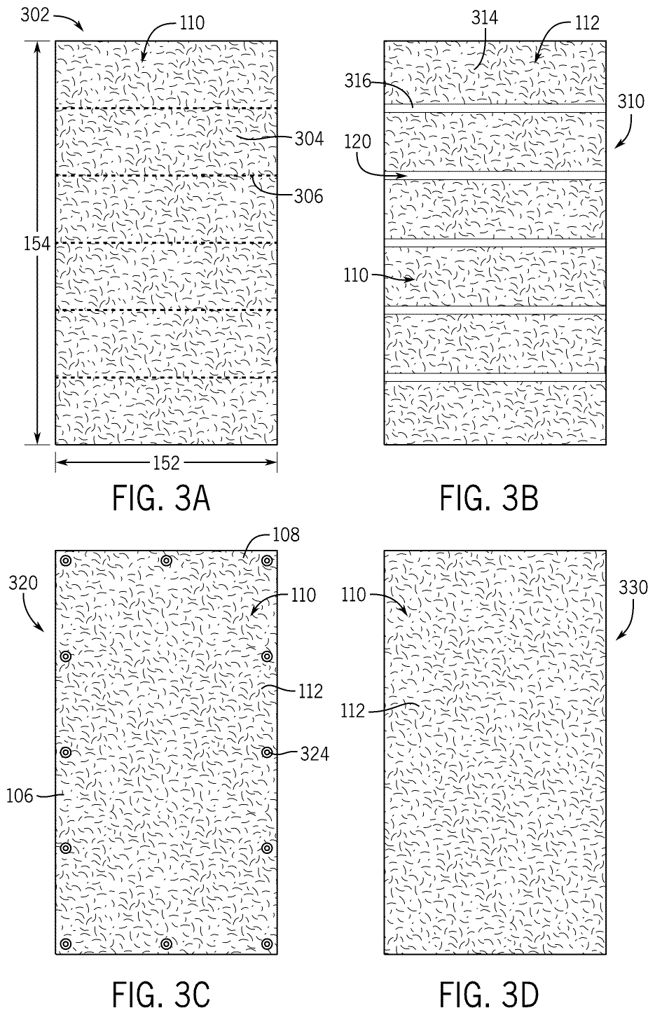

The mat 100, and each of the layers 110, 120, 130, may be flexible to fold or roll the mat 100 between a first expanded or flat configuration, and a second or more compact configuration. For example, as shown in FIG. 1, the mat 100 may be rolled for storage, or carrying, by positioning the mat 100 in a configuration with a reduced area. For the mat 100 to be rollable or foldable, the mat 100 may be thin in comparison to the length 154 or width. As shown in FIG. 2, the mat 100 has a total thickness 160. The total thickness 160 is defined by the combined thickness of the first layer 110, second layer 120, and optionally the third layer 130. The first layer 110 has a thickness 161. In one example, the first layer 110 has a thickness 161 between approximately 0.1 and 10 millimeters (e.g. less than one inch), but may be thicker or thinner in various examples. The second layer 120 has a thickness 162. In one example, the second layer 120 has a thickness 162 between 0.5 and 50 mm (e.g. less than one inch to a few inches) but may be thicker or thinner in various examples. The third layer 130, if included, has a thickness 163. In one example, the third layer has a thickness 163 between 0.5 and 50 mm (e.g. less than an inch to a few inches) but may be thicker or thinner in various examples.

The total thickness 160 may be between 2 and 100 mm (e.g. less than an inch to a few inches). In another example, the thickness 160 can be more or less. The mat 100 may be thinner or thicker depending on the number of layers 110, 120, 130, continuity of the layers, or the types of materials in the layers. The thickness 160 of the mat may also vary based on configuration of the mat 100 to prioritize moisture absorption, padding, or grip.

In one embodiment, the maximum or total thickness 160 may be around 3 mm to 6 mm, which will help to ensure that the mat 100 can be rollable or readily washable, such as in a washing machine, or the like. In other embodiments the thickness may be larger than 3 mm, such as in examples including a thicker support or padding layer 120, or wherein the mat includes additional layers or other features, such as to improve grip or total moisture absorption properties. For example, the first layer 110 may thickness 161 may vary between approximately 1-4 mm, or thinner or thicker, depending on the material and whether the material has a texture or features extending form the top surface 112. The second layer 120 thickness 162 may be between approximately 1-5 mm, but may be thinner or thicker depending on the padding or support of the second layer 120. The third layer 130 thickness 163 may be as thin as a coating or up to approximately 4 mm, or thicker or thinner in additional examples or depending on the material selected.

In some examples, one or more the layers 110, 120, 130 may further define sub layers or portions. For example, multiple materials may be used to form a layer 110, 120, 130. In some examples, supplemental portions having features corresponding to the first 110, second 120, or third layers 130 may be selectively added to the mat 100. For example, additional or fourth layers may be added for moisture absorption, padding, or grip.

Any of the features, components, and/or parts, including the arrangements and configurations thereof shown in FIG. 1 or FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1 or FIG. 2.

FIGS. 3A-3D show various example configurations of the mat 100. FIG. 3A shows an example configuration 302 of the mat 100 where at least the first layer 110 includes one or more scams 306. In some examples, the seams 306 may be defined by or extend through or into each of the first layer 110, second layer 120, or optionally the third layer 130 (if included). The one or more seams 306 may extend across all or at least a portion of the width 152 of the mat 100. The seams 306 may divide the first layer 110, or the mat 100, into one or more panels 304. The seams 306 may be a type of connection 140, such as stitching, melt lines, or fasteners. In some examples, the seams 306 may be breaks, indents, or grooves within a layer. In examples where the seams 306 define the connections 140, the connections 140 may be discretely positioned along the layers 110, 120, 130 for case of use in aligning and connecting or disconnecting the layers 110, 120, 130, such as for washing, cleaning, or drying.

The seams 306 or panels 304 may assist in transitioning the mat 100 to a rolled or folded configuration for transportation or storage. For example, the seams 306 may define natural fold lines, or increase the pliability or flexibility of the mat 100. For example, the seams 306 may define an area of a reduced thickness of the mat 100 or the first layer 110. The reduced thickness of the seams 306 may decrease a radius of curvature of the mat 100 when the mat 100 is transitioned to compact configuration (e.g. rolled or folded) for a tighter roll or smaller folded configuration. A flexible or foldable mat 100 may fit into a washing machine, or other cleaning container.

In some examples, each or some of the panels 304 may be divided by the seams 306 for different levels of cushioning or drying material in each of the panels 304. For example, the panels 304 may include different thicknesses or type of materials for one or more of the layers 110, 120, 130. In one example, the mat 100 may be directional with a first panel 304 configured to support a head or neck region, such as by providing a greater amount of padding or moisture absorption, and a second panel 304 may support a leg region or other body portion requiring a lesser amount of padding or moisture absorption. In such an example, the seams 306 may assist in identifying or separating the different panels 304.

FIG. 3B depicts an example configuration 310 of the mat 100. In the example configuration 310, the mat 100 may include a first layer 110 defining two or more panels 314 separated by a gap 316. In some examples, the gaps 316 define separations between the panels 314. The gap 316 may be an opening extending through to the second layer 120. In such an example, the first layer 110 may have a sufficient thickness 161 to space a user from the second layer 120 and absorb moisture. The gaps 316 may also increase the exposed surface area of the first layer 110 to assist in drying the first layer 110. In other examples, the gaps 316 may be a recess or depression in a portion of the first layer 110.

As with the example configuration 302, panels 314 separated by gaps 316 may assist in folding or rolling the mat 100. For example, the gaps 316 may define natural fold lines, or increase the pliability or flexibility of the mat 100. Accordingly, the example configuration 310 of the mat 100 may be transitioned easily to a compact configuration for storage or cleaning.

Arranging the first layer 110 into two or more panels 314 may also assist in cleaning the first layer 110. In examples where the first layer 110 is defined by separately defined panels 314, the panels 314 may each be selectively attachable to or removable from the mat 100 or second layer 120 for washing or cleaning. The smaller sizes of the panels 314, in comparison to an entire mat 100, may more easily fit within a washer or cleaning basin. The separately defined panels 314 may also be individually replaced, such as when a panel 314 becomes worn, or during longer workouts when a fresh and dry panel 314 may be comfortable.

FIG. 3C depicts an example configuration 320 of the mat 100 where one or more of the layers 110, 120, 130 may be selectively connected by fasteners 324. In the example configuration 320, at least the first layer 110 may be selectively connected to the second layer 120 or mat 100 by fasteners 324. In some examples, the second 120 and third layer 130 may be selectively connected by fasteners 324. The fasteners 324 may be snaps, buttons, hook and loop portions, zippers, magnets, or the like. The fasteners 324 may extend through all or a portion of the layers 110, 120, 130, or the fasteners 324 may be positioned between the layers 110, 120, 130.

The fasteners 324 may be positioned at discrete positions at or along the periphery 106 or corners 108 of the mat 100. Positioning the fasteners 324 at the corners 108 or periphery 106 spaces the fasteners 324 from portions of the mat 100 that may be commonly used by a user, such as the more central regions of the mat 100. Accordingly, the user may avoid contact with a fastener 324 that may be more rigid than the mat 100. Further, the discrete position of the fasteners 324, or corresponding portions of the fasteners 324, on the layers 110, 120, 130 may define a consistent alignment for each of the layers 110, 120, 130. The consistent alignment may ensure portions of the mat 100 include each of the first 110 and second layers 120, and optionally the third layer 130, for consistent support and moisture absorption during each use of the mat 100. Selectively connecting one or more of the layers 110, 120, 130 by fasteners 324 may assist a user in identifying which portions of the layers 110, 120, 130 should be aligned for connection or separated for removal. By quickly identifying the portions of the layers, the user may more quickly set up or clean the mat 100.

In some examples, as exemplified in the example configuration 330 shown in FIG. 3D, the first layer 110 may define a continuous top surface 112, which may further be a featureless top surface 112 or have a consistent thickness 161. A continuous top surface 112 may have consistent moisture absorption over the first layer 110. A continuous first layer 110 may be beneficial for workouts where the user may move between multiple different positions where they may be unable to consistently align themselves on the mat 100. In examples where the first layer 110 is continuous, connections 140 may be defined between the layers 110, 120, 130.

Any of the features, components, and/or parts, including the arrangements and configurations thereof shown in FIGS. 3A-3D can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 3A-3D.

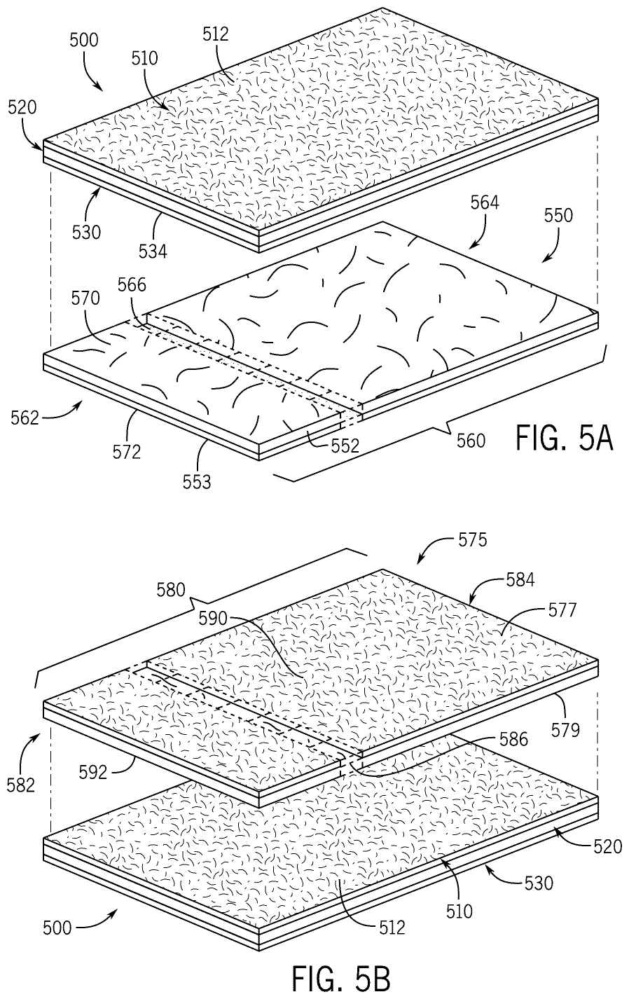

Turning to FIGS. 4A-4D, various example configurations of the optional third layer 130 are depicted. In some examples, the third layer 130 may be omitted and the features described with reference to the third layer 130 may be characteristics of the second layer 120. In some examples, the features or configurations described with respect to the third layer 130 can be a portion of the second layer 120, such as a second layer 120 having adhesive properties or providing frictional resistance on an environmental surface.

The third layer 130 may be continuous or cover the second layer 120, or the third layer 130 may be defined by separately placed portions connected to the second layer 120. A discontinuous third layer 130 may be useful to reduce a total weight of the mat 100, or to limit a total thickness 160 over portions of the mat 100. A lighter or thinner mat 100 may be more easily positioned or carried. In some examples, a continuous third layer 130 may define a continuous bottom surface 132 with strong frictional resistance or adhesive properties to limit movement of the mat relative to a support surface 190. However, depending on the material used, a continuous third layer 130 may be difficult to reposition during a workout, and a discontinuous third layer 130 may be more easily repositioned.

FIG. 4A shows example configurations of a discontinuous or discretely positioned portions defining the third layer 130. For example, the third layer 130 may include a perimeter feature 402 positioned along or adjacent all or a portion of the periphery 106. The third layer 130 may include one or more elliptical portions 404, rectangular portions 406, triangular portions 408, or other configurations of portions. The portions 404, 406, 408 may be arranged in the corners 108. Positioning the third layer 130 at the corners 108 of the mat 100 or second layer 120 may maintain a consistent thickness 160 of the mat 100 where the user may commonly be positioned. For example, a third layer 130 may have a thickness 163 noticeable to a user and by positioning discontinuous portions defining the third layer 130 at the corners 108 or periphery 106, the third layer 130 may be spaced from the user.

In some examples, the portions 402, 404, 406, 408 may be selectively connected to the bottom surface 124 of the second layer 120. For example, the top surface 132 of the third layer 130 may define or include features, such as an adhesive or fastener, to connect the third layer 130 to the second layer 120. By selectively connecting a one or more portions 402, 404, 406, 408 of the third layer 130, a user may customize a mat 100 to have a grip corresponding to their size or preferences.

FIG. 4B shows example configurations 420 of a discontinuous third layer 130 with longitudinally or latitudinally extending and portions. For example, the third layer 130 may include or be defined by one or more portions extending across all or a portion of the length 154 or width 152 of the mat 100.

The third layer 130 may include two or more laterally extending portions 422. The lateral portions 422 may extend across all or a portion of the width 152 of the mat 100. The lateral portions 422 may extend a longitudinal length 424. In some examples, each lateral portion 422 may have the same or different longitudinal length 424. The lateral portions 422 may be spaced along the length 154 of the mat 100 by a gap 426. The gap 426 may be defined by a channel, groove, or recess between the lateral portions 422. The second layer 120 may be exposed at the gap 426.

The third layer 130 may include two or more longitudinally extending portions 432. The longitudinally extending portions 432 may extend across all or a portion of the length 154 of the mat 100. The longitudinal portions 432 may extend a latitudinal width 434. In some examples, each longitudinal portion 432 may have the same or different latitudinal width 434. The longitudinal portions 432 may be spaced apart by gap 436. The gap 436 may be defined by a channel, groove, or recess between the lateral portions 432. The second layer 120 may be exposed at the gap 436.

The latitudinal 422 or longitudinal portions 432 may be selectively connected to the second layer 120. For example, the portions 422, 432 may include an adhesive or fastener. The portions 422, 432 may be positioned to correspond to likely or common positions or workouts of a user. For example, longitudinally extending portions 432 may resist movement of the mat during movements by the user along the width 152 of the mat 100. Latitudinal extending portions 422 may resist movement of the mat 100 during movements by the user along the length of the mat 100.

Longitudinal 432 or lateral 422 spaced portions of the third layer 130 may also assist in transitioning the mat 100 to a more compact configuration. For example, similar to example configurations 302 and 310, separating the third layer 130 by the gaps 426, 436 may result in a foldable or flexible mat 100 by reducing the total thickness 160 over some portions. The gaps 426, 436 may also define a volume to direct moisture on the environmental surface 190 away from the third layer 130, or out from beneath the mat 100.

FIG. 4C depicts another example configuration 440 of the mat 100. In the example configuration 440, the third layer 130 may define a plurality of apertures or recesses 442 in the bottom surface 134. The apertures 442 may extend partially or all the way through the third layer 130. For example, the apertures 442 may be defined through to the second layer 120. In other examples, the apertures 442 are depressions extending only partially through the thickness 163 of the third layer 130.

The apertures 442 may assist in resisting movement of the mat 100 along an environmental surface 190. For example, the apertures 442 may generate suction against the environmental surface 190. In some examples, the third layer 130 is compressible or deformable and the portions of the third layer 130 defining the apertures 442 may resiliently deform to contact the environmental surface 190 to increase a total surface area and frictional resistance. In some examples, the apertures 442 may define a volume to evacuate or direct moisture, such as perspiration, away from the bottom surface 134. As a result, the apertures 442 may decrease the effect of moisture on the frictional resistance of the third layer 130.

The apertures 442 may reduce a total weight of the third layer 130 or mat 100 for ease of carrying. The apertures 442 may also result in a more flexible third layer 130, assisting in rolling or storing the mat 100 in a more compact configuration.

FIG. 4D depicts another example configuration 450 of the mat 100. In the example configuration 450 of the mat 100, the mat 100 may include a continuous third layer 130 defining the bottom surface 134. The third layer 130 may be smooth or define one or more features 452 to assist in providing grip to the mat 100. For example, the third layer 130 may have adhesive properties or a high coefficient of friction or include a coating providing such properties. The features 452 may be one or more pores, grooves, channels, ridges, or the like. The features 452, similar to the apertures 442, may increase a surface area of the third layer 130 in contact with an environmental surface 190, or assist in evacuating moisture.

Any of the features, components, and/or parts, including the arrangements and configurations thereof shown in FIGS. 4A-4D can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 4A-4D.

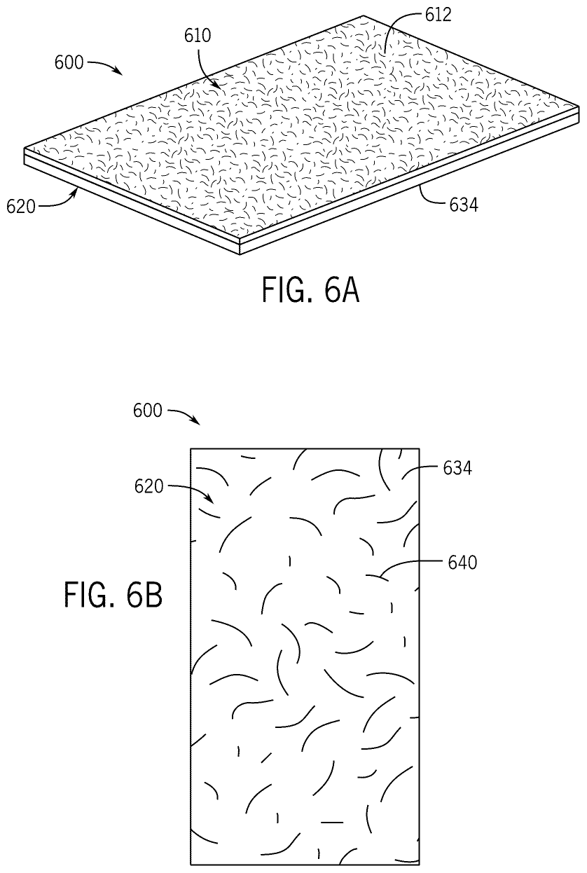

FIGS. 5A-5B depict an example mat 500 and selectively attachable supplemental portions 550 or 575. The supplemental portions 550, 575 may be selectively attached to the mat 500 for increased padding, grip, or additional moisture absorption. The supplemental portions 550, 575 may define an additional or fourth layer of the mat 100 when attached.

The mat 500 may be similar to or the same as the mat 100. The mat 500 includes a first layer 510 for absorbing or wicking moisture. The mat 500 includes a second layer 520 providing padding or support for a user during exercise. The mat 500 optionally includes a third layer 530 to grip or resist movement relative to an environmental surface, such as a floor. In some examples, the second layer 520 has properties corresponding to some or all of the properties described with reference to the third layers 130, 530. The mat 500 includes a top surface 512 and a bottom surface 534 opposite the top surface 512.

FIG. 5A depicts an example supplemental portion 550 for placement below or connection to the bottom 534 of the mat 500. The supplemental portion 550 may provide padding or grip in addition to the mat 500. The supplemental portion 550 may include one or both of a padding layer 552 or a grip layer 553. The padding layer 552 may be similar to the second layer 520. The grip layer 553 may be similar to the third layer 530.

In some examples, supplemental portion 550 may be a single body 560 having a similar or same length or width as the mat 500. In some examples, the supplemental portion 550 may be a single body 560 having a smaller or greater width or length than the mat 500. In some examples, the supplemental portion 550 may be or include a first panel 562 and a second panel 564. In some examples, the first panel 562 and the second panel 564 may be separately defined portions. In some examples, the first panel 562 and the second panel 564 may be selectively connected by a bridge portion 566 to form the single body 560. The first panel 562 may have a length or width less than the second panel 564. Each of the first panel 562 and the second panel 564 may have a length or width less than the mat 500.

The supplemental portion 550, or the first panel 562 and second panel 564, include a top surface 570 and an opposite bottom surface 572. The supplemental portion 550 may be selectively connected to or placed in contact with the bottom 534 of the mat 500. In some examples, the top surface 570 of the supplemental portion 550 may include one or more features to assist in limiting movement of the supplemental portion 550 relative to the mat 500. For example, the top surface 570 may have an adhesive or grippy coating, fasteners, or the like. The third layer 530 may provide sufficient grip or frictional resistance to limit movement of the supplemental portion 550 relative to the mat 500. In some examples, the third layer 530 may include corresponding features to selectively connect with the supplemental portion 550. FIG. 5B depicts an example supplemental portion 575 for placement above or

connection to the top 512 of the mat 500. The supplemental portion 575 may include layers for padding or moisture absorption in addition to the mat 500. The supplemental portion 575 may include one or both of a padding layer 579 or a towel layer 577. The padding layer 579 may be similar to the second layer 520. The towel layer 577 may be similar to the first layer 510.

The supplemental portion 575 includes a top surface 590 and a bottom surface 592. The supplemental portion 575 may be similar to the supplemental portion 550 and in some may be a single body 580 having a similar or same length or width as the mat 500. In some examples, the supplemental portion 575 may be or include a first panel 582 and a second panel 584. In some examples, the first panel 582 and the second panel 584 may be separately defined portions or selectively connected by a bridge portion 586. The first panel 562 may have a length or width less than the second panel 564. Each of the first panel 562 and the second panel 564 may have a length or width less than the mat 500.

The supplemental portion 575, or the first panel 582 and second panel 584, may be selectively connected to or placed in contact with the top 512 of the mat 500. In some examples, the bottom surface 592 of the supplemental portion 550 may include one or more features to assist in limiting movement of the supplemental portion 575 relative to the mat 500. For example, the bottom surface 592 may have an adhesive or grippy coating or portions, fasteners, hook and loop fasteners, or the like. In some examples, the first layer 510 may include corresponding features to selectively connect with the supplemental portion 575.

During use, the supplemental portion 550 may be used for increased padding and/or grip in combination with the mat 500. The supplemental portion 550 may be especially useful when if the bottom 534 of the mat 500 becomes wet, or when a workout position or user requires additional padding or support. The body 560 configuration may have a length or width sufficient for padding or grip under all or a portion of the mat 500. The first panel 562 may be useful for additional padding or grip for targeted regions, such as under the head or neck of a user. The second panel 564 may define additional padding or grip for a larger portion of a user's body, such as their torso.

Similarly, the supplemental portion 575 may be used for increased padding and/or moisture absorption in combination with the mat 500. The supplemental portion 575 may be especially useful when the mat 500 becomes increasingly wet, or when there is insufficient time in the workout to replace the first layer 510. The body 580 may be useful in providing padding or moisture absorption over all or a portion of the mat 500. The first panel 582 may be useful in providing moisture absorption or padding for a targeted or especially wet region, such as the head or neck or regions of the mat in contact with exposed skin. The second panel 584 may define padding or moisture absorption over a larger area.

Any of the features, components, and/or parts, including the arrangements and configurations thereof shown in FIGS. 5A-5B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 5A-5B.

FIGS. 6A-6B depict another example of the mat 600, and FIG. 6C illustrates another example of the mat 602 similar to mat 600. The mat 600 includes only a first moisture absorbing layer 610 and a second supportive or padded layer 620. The mat 600 may include the first layer 610 for providing moisture absorption or moisture wicking properties. The first layer 610 may define a top surface 612. The mat 600 may include the second layer 620 for providing padding or support for a user on the mat 600. The first layer 610 can include all or some of the properties and features of the first layers (e.g. layer 110) described herein. The second layer 620 can include all or some of the properties and features of the second layers (e.g. layer 120) and/or the optional third layer (e.g. layer 130) described herein.

The mat 600 may not include a separate layer providing grip or frictional resistance in addition to the second layer 620. Instead, the second layer 620 may define the bottom surface 634. The bottom surface 634 may define one or more features 640 for grip or frictional resistance with the environmental surface to limit movement of the mat 600. For example, the features 640 may be pores, grooves, channels, ridges, folds, or the like to increase a surface area and frictional resistance of the second layer 620. In some examples, the second layer 620 may include a coating or adhesive along all or a portion of the bottom surface 634 to limit or resist movement of the mat 600. In some examples, the second layer 620 may include a material providing both padding and having a high coefficient of friction, thereby providing support and limiting movement of the mat 600.

FIG. 6C illustrates a mat 602 having the first layer 610 and the second layer 620 and including shaped corners 608 to provide an aesthetic benefit to the exercise mat 602. The mat 602 includes a first end 604 and a second end 606, with the corner region 608 extending between the ends 604, 606. In some examples, only the corner region 608 of the first layer 610 or the second layer 620 are shaped. In such an example, the other layer can be shaped differently at the corner region 608 and may or may not be coextensive with the other layer (e.g. extend outward or be recessed inward).

The corner region 608 can be angled or curved. In an angled example, the corner region 608 may be one or more edges extending at an angle relative to each of the edges 604, 606. For example, corner region 608 may be oriented at 10, 20, 30, 40, 50 degrees or more or less relative to at least one of the ends 604, 606. In one example, the corner region 608 is offset at 45 degrees relative to each end 604, 606. In a curved example, the corner region 608 may have a consistent or variable radius between the ends 604, 606.

The various shapes of the corner regions 608 can assist in providing an aesthetic benefit to the mat 602. For example, the corner regions 608 can give the mat 602 the visual impression of a desirable shape, design, character, or the like. The visual impression of the mat 602 provided by the corner regions can assist a user in identifying the mat over alternative exercise mat products.

It is appreciated that any of the features, components, and/or parts, including the arrangements and configurations thereof shown in FIGS. 6A-6C can be included, cither alone or in any combination, in any of the other examples of the mats, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 6A-6C.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and Band C). Further, the term “exemplary” does not mean that the described example is preferred or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A mat for supporting a user during an exercise comprising:
a first layer having moisture absorption or moisture wicking properties and defining an upper surface;
a second layer positioned below and coupled to the first layer and resiliently deformable to define cushioning; and
a bottom surface for selective interfacing with an environmental surface to limit movement of the mat relative to the environmental surface;
wherein the mat is flexibly manipulable between a first expanded configuration and a second compact configuration, the second compact configuration having a reduced area in comparison to the first expanded configuration.

2. The mat of claim 1, further comprising:
a third layer defining the bottom surface and coupled to the second layer, wherein the third layer comprises a material having a sufficiently high coefficient of friction to limit the movement of the mat relative to the environmental surface.

3. The mat of claim 2, wherein the first layer and the second layer, or the third layer are fixedly coupled.

4. The mat of claim 2, wherein:
the third layer covers a lower surface of the second layer.

5. The mat of claim 1, wherein a combined thickness of the first layer and the second layer, is between and including 2 millimeters to 8 millimeters.

6. The mat of claim 1, wherein:
the first layer or the second layer are defined by two or more panels, and
the two or more panels are movable relative to each other.

7. The mat of claim 1, wherein:
an additional layer comprising properties of one or both of the first layer or the second layer is selectively coupled to the upper surface or the bottom surface.

8. The mat of claim 1, wherein:
the first layer is defined by a first material comprising synthetic fibers.

9. The mat of claim 1, wherein the synthetic fibers comprise polyester and nylon.

10. The mat of claim 1, wherein:
the bottom surface includes one or more pores, a tacky coating, grooves, or ridges.

11. The mat of claim 1, wherein the second layer defines the bottom surface and the upper surface defines a top most surface.

12. An exercise mat for supporting a user during an exercise comprising:
a top layer comprised of a moisture absorptive material and defining a top surface;
a second layer coupled to the first layer opposite the top surface and formed of a resiliently deformable material; and
a bottom surface for selective interfacing with an environmental surface to limit movement of the mat relative to the environmental surface;
wherein the exercise mat is flexibly manipulable between a first expanded configuration and a second compact configuration, the second compact configuration having a reduced area in comparison to the first expanded configuration.

13. The exercise mat of claim 12, wherein:
the top layer is comprised of a fibrous material; and
the second layer is comprised of rubber.

14. The exercise mat of claim 12, wherein:
the top player is suede; and
the second layer defines the bottom surface and is comprised of rubber.

15. The exercise mat of claim 14, wherein:
the top layer and the second layer terminate at a first end and a second end,
a corner region extends between the first end and the second end, and
the corner region is oriented at an angular offset relative to the first end.

16. The exercise mat of claim 15, wherein the angular offset is 45 degrees.

17. The exercise mat of claim 12, wherein a combined thickness of the top layer and the second layer, is between and including 2 millimeters to 8 millimeters.

18. An exercise mat for supporting a user during an exercise comprising:
a top layer comprised of a moisture absorptive material and defining a top surface and a lower surface opposite the top surface;
a second layer positioned coupled to and extending coextensively along the lower surface of the first layer and formed of a resiliently deformable material; and
a bottom surface for selectively engaging with an environmental surface to limit movement of the mat relative to the environmental surface;
wherein the top layer and the second layer are flexibly manipulable between a first expanded configuration and a second rolled and compact configuration, the second rolled and compact configuration having a reduced area in comparison to the first expanded configuration.

19. The exercise mat of claim 18, wherein:
the top player is suede; and
the second layer defines the bottom surface and is comprised of rubber.

20. The exercise mat of claim 18, wherein:
the top layer and the second layer terminate at a first end and a second end,
a corner region extends between the first end and the second end, and
the corner region is oriented at an angular offset between and including approximately 30-60 degrees relative to the first end.
